(19) United States
(12) Patent Application Publication
(10) Pub. No.: US 2024/0278920 A1
(43) Pub. Date: Aug. 22, 2024

(54) SEATING DEVICE

(71) Applicant: RECARO Aircraft Seating GmbH & Co. KG, Schwaebisch Hall (DE)

(72) Inventors: Sandra HUBER, Unterhaching (DE); Stefanie ECKERT, Schwaebisch Hall (DE); Christoph BICH, Mutlangen (DE); Zoltan JUSSLI, Bretzfeld (DE); Felix BAUER, Konstanz (DE); Nastia KUHN, Schwaebisch Hall (DE)

(21) Appl. No.: 18/568,961

(22) PCT Filed: Jun. 24, 2022
(86) PCT No.: PCT/EP2022/067401

§ 371 Date: Dec. 11, 2023

(30) Foreign Application Priority Data
Jun. 25, 2021 (DE) 10 2021 116 542.3

(51) Int. Cl. B64D 11/06

(52) U.S. Cl. CPC B64D 11/0648; B64D 11/0649

(57) ABSTRACT

A seat device, in particular an aircraft seat device, includes a backrest having a base frame which includes two lateral frame elements, and a shell element which is connected to the lateral frame elements and at least partly forms a backrest support surface.

### CROSS-REFERENCE TO RELATED APPLICATIONS

This patent application is a U.S. national stage application of international patent application PCT/EP2022/067401, filed on Jun. 24, 2022, which is based on and claims priority to German patent application DE 10 2021 116 542.3, filed on Jun. 25, 2021, the contents of which are incorporated herein by reference.

### PRIOR ART

The invention concerns a seat device.

A seat device, in particular an aircraft seat device, with a backrest having a base frame which comprises two lateral frame elements, has already been proposed.

The object of the invention is in particular to provide a generic device with improved properties with respect to construction. The object is achieved according to the invention.

### Advantages of the Invention

According to the invention, a seat device, in particular an aircraft seat device, is proposed, with a backrest having a base frame which comprises two lateral frame elements, and having a shell element which is connected to the lateral frame elements and at least partly forms a backrest support surface. The design according to the invention allows a particularly advantageous construction to be achieved. With the design according to the invention, a seat device can be provided with an advantageously low weight. Furthermore, with the design according to the invention, the number of components can advantageously be reduced. Production costs can thereby be advantageously reduced. In addition, an advantageously simple mounting becomes possible. Furthermore, the design according to the invention advantageously improves comfort, in particular with respect to leg room, since in particular a depth of the backrest can advantageously be reduced. Furthermore, an advantageously durable construction can be achieved.

Preferably, the seat device, in particular the aircraft seat device, is configured to be mounted on a seat, in particular on an aircraft seat. Preferably, the seat device is part of the seat, in particular the aircraft seat. Preferably, the seat comprises a mounting unit. Preferably, the seat is configured to be mounted on a mounting plane. The term “configured” is to mean specifically designed and/or equipped. The phrase that an object is configured for a specific function in particular means that this object fulfils and/or executes this specific function in at least one application and/or operation state.

Preferably, the base frame is configured to transmit to the mounting unit the forces introduced into the backrest, in particular passenger support forces. Preferably, the shell element is configured to conduct the passenger support forces acting on the shell element into the base frame. A “shell element” preferably means a superficially large component which is curved and/or bent. Preferably, the backrest, in particular the base frame, is supported pivotably relative to the mounting unit. Preferably, the two lateral frame elements are configured to divert to the mounting unit the forces introduced into the backrest, in particular the passenger support forces. Preferably, the lateral frame elements are each formed as a hollow profile. Preferably, the lateral frame elements are each arranged at least substantially in a laterally outer region of the backrest. Preferably, the frame elements extend at least substantially along the backrest support surface. The term “at least substantially” preferably means that a deviation from the predefined value amounts in particular to less than 25%, preferably less than 10% and particularly preferably less than 5% of the predefined value.

Preferably, the shell element, in particular the backrest support surface, is configured to receive passenger support forces and conduct these into the lateral frame elements. Preferably, the shell element is directly connected to the lateral frame elements. Thus passenger support forces can advantageously be conducted from the backrest support surface into the base frame. Preferably, at least a majority of the shell element is arranged between the lateral frame elements. The term “at least a majority” preferably means at least 55%, advantageously at least 65%, preferably at least 75%, particularly preferably at least 85%, and particularly advantageously at least 95% of a component volume of the shell element. Preferably, in a fully completed state of the shell element, in particular as a single individual component, and in unmounted state of the seat device, the shell element is formed separately from the base frame. Preferably, the shell element is made at least partly from a fiber composite material, in particular an organic sheet. In principle, the shell element can be made from a prepreg material. Preferably, the fiber composite material comprises glass fibers and/or carbon fibers. Alternatively, the shell element may be formed at least partially from a metallic material. In principle, it would also be conceivable for the shell element to be formed from an injection-molding. Preferably, the shell element has a concave form on a front side of the shell element. Preferably, the front side of the shell element at least partly forms the backrest support surface. A “backrest support surface” preferably means a surface which is configured to receive passenger support forces, in particular from a passenger's back. “Passenger support forces” mean preferably forces which act on the backrest, in particular the backrest support surface, when the passenger leans on the backrest. Preferably, at least one cover element and/or at least one padding element is arranged between the backrest support surface and the passenger. Alternatively, it would also be conceivable for the passenger to make direct contact with the backrest support surface.

It is furthermore proposed that the shell element is arranged exclusively in the lower region of the backrest. With this design, an advantageously compact construction of the seat device in the lower region of the backrest can be achieved. Furthermore, thereby advantageously, a targeted reinforcement of the lower region of the backrest can be achieved, in particular in a region in which the passenger's posterior exerts forces on the seat device. Thus the seat device can be formed advantageously light and same time stable. The phrase “lower region of the backrest” preferably means a region of the backrest which is closer to a seat bottom of the seat and/or the mounting unit of the seat than to a backrest upper edge of the backrest. Preferably, the lower region of the backrest is arranged in a lower half, in particular a lower third, of the backrest. Preferably, the lower region of the backrest extends from the mounting unit and/or the seat bottom towards the backrest upper edge. Preferably, the lower region extends from the seat bottom up to a hip region of an average passenger. Preferably, the shell element functions as a lumbar support. Preferably, an upper region of the backrest is free of the shell element. Particularly preferably, the upper region of the backrest as a whole is free of a shell element which is connected to the lateral frame elements and at least partly forms the backrest support surface. Preferably, the upper region of the backrest as a whole is free of a shell element which is arranged in the region of the backrest facing the passenger and which at least partly forms the backrest support surface. The term “upper region of the backrest” preferably means a region of the backrest which is closer to the upper edge of the backrest than to the seat bottom of the seat and/or the mounting unit of the seat device. Preferably, the upper region of the backrest is arranged in an upper third, in particular in an upper quarter of the backrest. Preferably, the upper region of the backrest is arranged in a region above a shoulder region of an in particular average passenger. The term “arranged exclusively in a lower region of the backrest” means that the shell element does not extend into the upper region of the backrest. In principle, above the shell element, in particular in the upper region of the backrest, function components of the seat device may be arranged which in particular may be formed shell-like but do not form part, in particular a direct part, of the backrest support surface. In principle, such a function component in the upper region of the backrest may be realized for example as a receiving structure for a headrest or as a crossbeam unit which connects the lateral frame elements together. Preferably, the shell element has no cutouts which form an area larger than 50 cm² and are formed as through holes. Preferably, the shell element is free from reinforcing elements on the front of the shell element.

It is furthermore proposed that the backrest has at least one covering element which is coupled to the base frame and to the shell element and partly forms the backrest support surface. With this design, an advantageously suitable force absorption at the different regions of the backrest can be achieved. Furthermore, with this design, a backrest support surface can be provided from multiple interconnected components. Thus a backrest support surface can be provided which is particularly advantageous with respect to different support forces. With this design, furthermore an advantageously strong and durable backrest can be achieved. Thus a particularly advantageous construction of the seat device can be achieved. Preferably, the at least one covering element is formed at least substantially from a textile. Preferably, the at least one covering element is clamped in the base frame. Preferably, the at least one covering element is clamped between the lateral frame elements. Preferably, the at least one covering element is connected to the lateral frame elements at least by form fit. Preferably, the at least one covering element has piping at its lateral ends, which is configured to be coupled to a piping rail on the lateral frame elements. Alternatively or additionally, the at least one covering element, in particular at its lateral ends, may be glued to the lateral frame elements and/or at least partially clamped around the lateral frame elements. Preferably, the at least one covering element extends in particular over at least 30%, preferably at least 40% and particularly preferably over at least 50% of a maximal longitudinal extent of the backrest. Preferably, the shell element and the at least one covering element together at least substantially form the backrest support surface.

It is also proposed that the covering element is arranged between the shell element and a crossbeam of the backrest, wherein the crossbeam is arranged in the upper region of the backrest. With this design, an advantageously suitable force absorption at different regions of the backrest can be achieved. Thus a backrest support surface which is particularly advantageous with respect to different support forces can be provided. With this design, furthermore, an advantageously strong and durable backrest can be achieved. Thus a particularly advantageous construction of the seat device can be achieved. Preferably, the crossbeam connects the lateral frame elements together. In principle, the crossbeam may be part of the base frame. Preferably, the upper region of the backrest extends from the backrest upper edge towards the mounting unit and/or the seat bottom. In principle, it is conceivable that the crossbeam forms the backrest upper edge. Alternatively however, it would also be conceivable that the crossbeam is spaced from the backrest upper edge. In principle, it is also conceivable that the crossbeam is part of a crossbeam unit which connects together the lateral frame elements in the upper region of the backrest by means of at least two transverse connections, wherein the transverse connections are formed by the crossbeam and a further crossbeam which is spaced apart from the crossbeam but connected thereto via the crossbeam unit. Preferably, the at least one covering element is arranged at least substantially in a region above the shell element. Preferably, the at least one covering element, in particular at its upper end, is attached to the crossbeam.

It is furthermore proposed that the shell element has at least one attachment region in which the covering element is attached to the shell element. With this design, the at least one covering element and the shell element can be advantageously coupled together. This design in particular ensures that the backrest support surface transforms without interruption from the shell element into the at least one covering element. Thereby a particularly advantageous construction of the seat device with respect to support and comfort can be achieved. Preferably, the at least one covering element contacts the shell element. Preferably, the at least one covering element is connected to the shell element by force fit and/or form fit, in particular in the at least one attachment region. An “attachment region” preferably means a region in which the at least one covering element and the shell element are connected together. Preferably, the shell element and the at least one covering element are arranged overlapping in a region above the at least one attachment region. Preferably, the at least one covering element and the shell element are connected together by means of at least one hook-and-loop connection. Alternatively, the at least one covering element and the shell element may be connected together by means of at least one press stud connection. In principle, other connecting means, which the person skilled in the art deems suitable for force fit and/or form fit connection of the at least one covering element to the shell element, are conceivable. In principle, it would also be conceivable that the at least one covering element is connected to the shell element by substance bonding, in particular in the at least one attachment region. Preferably, the shell element has at least one recess which is configured for connection of the at least one covering element to the shell element. Preferably, the at least one recess is formed as a passage hole. Preferably, the at least one recess is formed slot-like. Preferably, the at least one recess is arranged in the at least one attachment region. Preferably, the shell element and the at least one covering element are arranged overlapping in a region above the at least one recess. Preferably, the at least one covering element is guided through the at least one recess. Particularly preferably, the hook-and-loop connection extends from the front side of the shell element through the at least one recess to a rear side of the shell element. Thus an advantageously reliable and strong connection can be achieved. Preferably, the shell element has at least one depression. A “depression” preferably means a bulge of the shell element towards the rear side of the shell element. Preferably, the at least one depression has a concave shape on the front side of the shell element. Preferably, the at least one depression is configured to receive a volume of a hook-and-loop connection via which the padding element or the cover element is directly attached to the shell.

It is furthermore proposed that the shell element comprises at least one passage which forms a mounting region for a connection of the backrest, in particular a connection of the lateral frame elements, to the mounting unit. With this design, mounting and/or maintenance of the backrest can be advantageously simple. Furthermore, with this design, an advantageous accessibility of the connection using tools can be achieved.

Furthermore, with this design, it can advantageously be achieved that for mounting and/or maintenance of the backrest, it is only necessary to remove any cover element and/or padding element arranged on the backrest support surface, which advantageously keeps the time required for mounting and/or maintenance to a minimum. Thus a particularly advantageous construction of the seat device can be achieved. Preferably, the seat device comprises two bearing units which are each arranged at least partially in one of the lateral frame elements. Preferably, the connection of the backrest to the mounting unit, in particular the connection of the two lateral frame elements, takes place by means of the two bearing units. A “mounting region” preferably means a region which is required for an attachment to the backrest for components to be installed, such as e.g. parts of the bearing units, and/or tools. Preferably, the at least one passage is designed to provide access from the backrest support surface to at least one of the bearing units. A “passage” preferably means a cutout from the shell element. Preferably, the at least one passage extends through the shell element. Preferably, the backrest support surface is interrupted at the at least one passage. Preferably, the passage forms an area which in particular amounts to maximum 50 cm², preferably maximum 30 cm², and particularly preferably maximum 15 cm². Preferably, the at least one passage is arranged in a side region of the shell element. Preferably, the at least one passage is arranged between the lateral frame elements. In principle, it is conceivable that the at least one passage is arranged at least partly in a depression of the shell element. Preferably, the at least one passage is intersected by a backrest pivot axis. Preferably, the backrest is supported pivotably relative to the mounting unit via the backrest pivot axis. Preferably, the bearing units are configured for supporting the backrest pivotably relative to the mounting unit. Preferably, the backrest pivot axis is guided from behind the shell element through the at least one passage to the front side of the shell element.

It is furthermore proposed that the shell element, in an upper region of the shell element, has a protrusion extending towards the crossbeam. With this design, an advantageous support of a passenger's back can be achieved. Thus in particular an advantageously constant transition of the backrest support surface from the shell element to the at least one covering element can be achieved. Preferably, the protrusion is arranged in a middle of the upper region of the shell element. Preferably, the protrusion forms a transition to the at least one covering element and overlaps with the covering element. Preferably, the at least one covering element contacts the shell element on the front side of the shell element.

It is furthermore proposed that the shell element, in a lower region of the shell element, has a shape convex towards a mounting plane. With this design, an advantageous support of a passenger's posterior can be achieved. The support forces can thus advantageously be reliably absorbed by the shell element. Preferably, the shell element has a lower edge which has a shape that is convex towards the mounting plane.

It is also proposed that the shell element, on a top side of the shell element, is connected to a crossbeam of the backrest. With this design, an advantageously simple and rapid mounting of the seat device can take place. Thus a particularly advantageous construction of the seat device can be achieved. Preferably, the upper end of the shell element is fixedly connected to the crossbeam.

It is furthermore proposed that the shell element extends over at least 60% of a maximal longitudinal extent of the backrest. With this design, an advantageously simple and rapid mounting of the seat device can be achieved. Furthermore, with this design, an advantageously uninterrupted backrest support surface can be provided. Furthermore, with this design, support forces can be absorbed over an advantageously large area. Thus a particularly advantageous construction of the seat device can be achieved. Preferably, the shell element extends from a lower region of the backrest to an upper region of the backrest. Preferably, the shell element extends from a shoulder region to at least a lumbar region of an average passenger. Preferably, the crossbeam is arranged in the shoulder region or above the shoulder region.

It is furthermore proposed that the shell element comprises at least one function element which is molded, in particular injection-molded, onto the shell element. With this design, advantageously no components to be additionally produced and/or mounted on the base frame are required. Thus the shell element can be implemented in a particularly variable and versatile fashion. Furthermore, with this design, an edge protection for the shell element can advantageously be provided. Thus a particularly advantageous construction of the seat device can be achieved. A “function element” preferably means an element which is configured to fulfil a specific function. Preferably, the at least one function element is embodied as a fastening element, by means of which at least one unit and/or at least one element can be fastened to the shell element. Preferably, the shell element, which is in particular embodied as an organic sheet, can be molded in a production step into its definitive form, wherein simultaneously the at least one function element can be molded onto the shell element.

It is also proposed that the at least one function element is arranged on at least one lateral end of the shell element and forms a receiving space for a cover fastening element. With this design, an advantageously simple fastening of the at least one cover element becomes possible. Thus advantageously, no additional components to be mounted to the base frame are required. Preferably, the at least one lateral end of the shell element is arranged outside the base frame. Preferably, the receiving space is realized as an undercut, whereby the cover fastening element is held in the receiving space in mounted state. Preferably, the cover fastening element is configured for fastening the at least one cover element to the backrest. Preferably, the cover fastening element is coupled to the at least one cover element. In principle, the cover fastening element may be fixedly connected to the at least one cover element. Alternatively, the cover fastening element may, at least in portions, be guided in a channel of the at least one cover element. In principle, the cover fastening element may be embodied as a cable, a cord, a strap or another fastening means deemed suitable by the person skilled in the art. In principle, the cover fastening element may be elastic, for example as an expanding cable.

It is furthermore proposed that the at least one function element is arranged on a rear side of the shell element and is configured for attachment of at least one functional component to the backrest. With this design, an advantageously simple fastening can be achieved for the at least one function component which is configured for use by a passenger seated behind the backrest. Thus advantageously, no additional components to be mounted on the base frame are required. Preferably, the at least one function element is realized as a fastening element, in particular a screw insert. Preferably, by means of the at least one function element, a literature pocket may be attached to the shell element. Alternatively, it would for example be conceivable that by means of the at least one function element, a table device and/or a screen may be attached to the shell element. Preferably, the at least one function element is provided in addition to a reinforcement, in particular a stiffening of the shell element in the lower region of the backrest.

It is furthermore proposed that at least a portion of the shell element at least partly forms a rear visible surface of the backrest. With this design, a particularly compact seat device can be provided with an advantageously small depth. This may advantageously increase the living space. A “visible surface” is preferably a surface which, in fully mounted state of the seat, can be observed directly, in particular without manipulation of the seat, from an environment, in particular from a region behind the seat. Preferably, the shell element forms at least a lower portion of the rear visible surface of the backrest.

It is also proposed that the backrest has a further shell element which at least substantially terminates the backrest rearwards and forms a rear visible surface of the backrest, wherein the shell element and the further shell element are directly connected together. With this design, a particularly compact seat device can be provided with an advantageously small depth. Thus a living space can be advantageously increased.

Preferably, the shell element and the further shell element are connected together in the region between the lateral frame elements. Preferably, the further shell element is formed from a hot-shaped panel, in particular an aluminum sheet. Alternatively, the further shell element may be made of a plastic, in particular a fiber-reinforced plastic, or from another material which the person skilled in the art deems suitable.

Furthermore, an aircraft seat with the seat device is proposed.

The seat device according to the invention, and the aircraft seat according to the invention, are not restricted to the above-described application and embodiment. In particular, the seat device according to the invention and the aircraft seat according to the invention may have a number of individual elements, components and units which differ from the number cited herein in order to fulfil a function described herein.

### DRAWINGS

Further advantages arise from the following description of the drawings. The drawings illustrate three exemplary embodiments of the invention. The drawings, the description and the claims contain numerous features in combination. The person skilled in the art will also consider the features individually where applicable and combine them into further suitable combinations.

In the drawings:

FIG. 1 shows a schematic illustration of an aircraft seat according to the invention in a first exemplary embodiment, viewed from a side,

FIG. 2 shows a schematic illustration of a seat device according to the invention in the first exemplary embodiment, viewed from the front,

FIG. 3 shows a schematic, partial illustration of the seat device according to the invention in the first exemplary embodiment, viewed from the front,

FIG. 4 shows a schematic, partial illustration of the seat device according to the invention in the first exemplary embodiment, viewed from the rear,

FIG. 5 shows a schematic illustration of a seat device according to the invention in a second exemplary embodiment, viewed from the front,

FIG. 6 shows a schematic illustration of a seat device according to the invention in the second exemplary embodiment, viewed from the rear,

FIG. 7 shows a schematic illustration of a seat device according to the invention in the second exemplary embodiment, viewed from above,

FIG. 8 shows a schematic illustration of a seat device according to the invention in a third exemplary embodiment, viewed from the front,

FIG. 9 shows a schematic illustration of a seat device according to the invention in the third exemplary embodiment, viewed from the rear, and

FIG. 10 shows a schematic illustration of a seat device according to the invention in the third exemplary embodiment, viewed from below.

### DESCRIPTION OF EXEMPLARY EMBODIMENTS

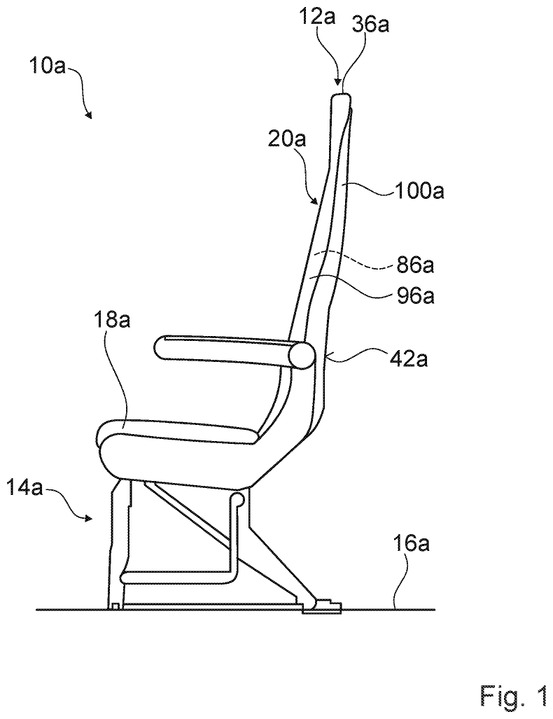

FIG. 1 shows a seat which is embodied as an aircraft seat 10a. The aircraft seat 10a in the present case is embodied as an economy class aircraft seat. The aircraft seat 10a comprises a seat device 12a. The seat device 12a in the present case is embodied as an aircraft seat device. The seat device 12a is configured to be mounted on the aircraft seat 10a. The aircraft seat 10a comprises a mounting unit 14a. The aircraft seat 10a is configured to be mounted on a mounting plane 16a by means of the mounting unit 14a. The aircraft seat 10a comprises a seat bottom 18a. The aircraft seat 10a may be part of an aircraft seat bank which preferably comprises at least two aircraft seats.

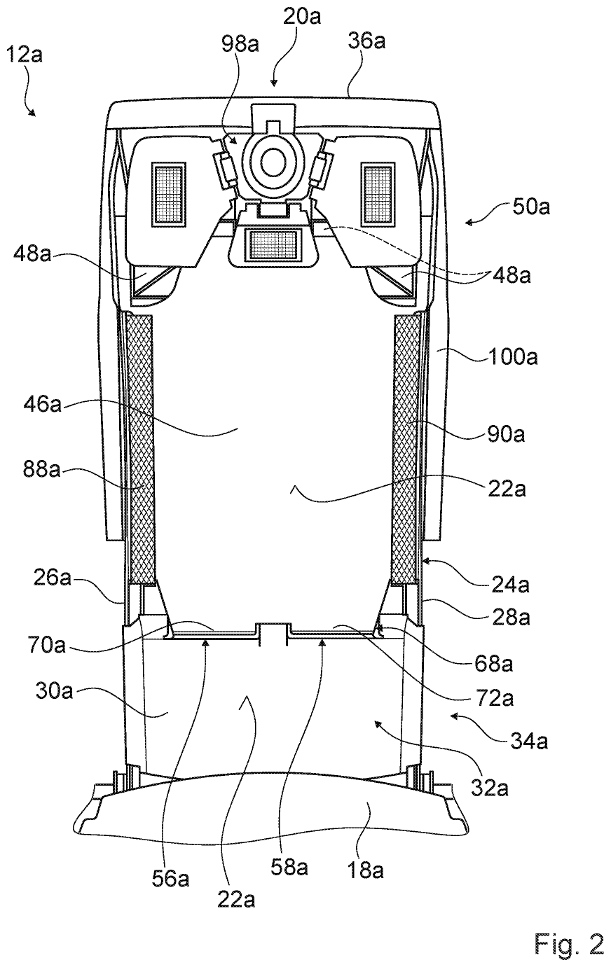

FIGS. 2 to 4 shows the seat device 12a in detail. The seat device 12a comprises a backrest 20a. The backrest 20a in the present case is supported pivotably relative to the mounting unit 14a. In principle, the backrest 20a may however also be mounted rigidly on the mounting unit 14a. The backrest 20a has a backrest support surface 22a. The backrest support surface 22a is configured to absorb passenger support forces, in particular from a passenger's back.

The backrest 20a has a base frame 24a. In the present case, the base frame 24a is supported pivotably relative to the mounting unit 14a. The base frame 24a is configured to transmit forces introduced into the backrest 20a, in particular passenger support forces, to the mounting unit 14a. The base frame 24a comprises two lateral frame elements 26a, 28a. The two lateral frame elements 26a, 28a are configured for diverting forces introduced into the backrest 20a, in particular passenger support forces, to the mounting unit 14a. The lateral frame elements 26a, 28a are coupled to the mounting unit 14a. The lateral frame elements 26a, 28a are each arranged substantially in a lateral outer region of the backrest 20a. The lateral frame elements 26a, 28a are each realized as a hollow profile. The lateral frame elements 26a, 28a each have a piping rail. The lateral frame elements 26a, 28a each extend substantially along the backrest support surface 22a.

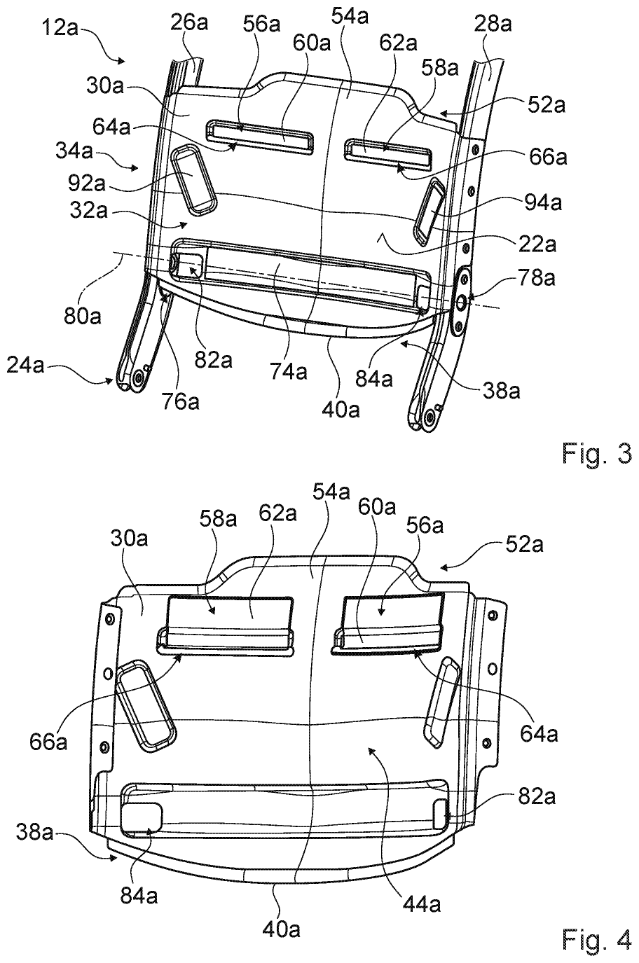

The backrest 20a has a shell element 30a. In FIG. 2, the shell element 30a is shown simplified, whereas in FIGS. 3 and 4, the shell element 30a is shown in detail. The shell element 30a is connected to the lateral frame elements 26a, 28a. The shell element 30a partially forms the backrest support surface 22a. The shell element 30a is configured to conduct passenger support forces, acting on the shell element 30a, into the base frame 24a. The shell element 30a, in particular the backrest support surface 22a, is configured to absorb passenger support forces and conduct these into the lateral frame elements 26a, 28a. The shell element 30a has a concave form on a front side 32a of the shell element 30a. The front side 32a of the shell element 30a partly forms the backrest support surface 22a. At least a majority of the shell element 30a is arranged between the lateral frame elements 26a, 28a. The shell element 30a overlaps the lateral frame elements 26a, 28a at the outsides, facing away from one another, of the base frame 24a in at least one region. On a front side of the base frame 24a, the shell element 30a is placed on the lateral frame elements 26a, 28a. In principle however, other couplings of the shell element 30a to the base frame 24a are conceivable. The shell element 30a is directly connected to the lateral frame elements 26a, 28a. The shell element 30a in the present case is connected by force fit and/or form fit to the lateral frame elements 26a, 28a. The shell element 30a is riveted to the lateral frame elements 26a, 28a. Alternatively or additionally however, it would also be conceivable that the shell element 30a is connected to the lateral frame elements 26a, 28a by substance bonding. For example, the shell element 30a could be connected to the lateral frame elements 26a, 28a via an adhesive connection. The shell element 30a is formed separately from the base frame 24a in a fully completed state of the shell element 30a, in particular as a single component, and in unmounted state of the seat device 12a, in particular the backrest 20a.

In the present case, the shell element 30a is arranged exclusively in a lower region 34a of the backrest 20a. The lower region 34a of the backrest 20a in this case is arranged in a lower third of the backrest 20a. An upper region 50a of the backrest 20a is free from the shell element 30a. The shell element 30a does not extend into the upper region 50a of the backrest 20a. The terms “lower” and “upper” each relate to a completely mounted state of the aircraft seat 10a with the seat device 12a. The lower region 34a of the backrest 20a extends from the mounting unit 14a and/or the seat bottom 18a towards a backrest upper edge 36a. The lower region 34a extends from the seat bottom 18a to a hip region of an average passenger. In the present case, the shell element 30a functions as a lumbar support.

In a lower region 38a of the shell element 30a, the shell element 30a has a shape that is convex towards the mounting plane 16a. The shell element 30a has a lower edge 40a which has a shape convex towards the mounting plane 16a.

The shell element 30a is made at least partly from a fiber composite material, in particular with glass fibers and/or carbon fibers. In the present case, the shell element 30a is formed at least substantially from an organic sheet. In principle, the shell element 30a may also be made from a prepreg material or another fiber-reinforced material deemed suitable by the person skilled in the art. Alternatively, the shell element 30a may be formed at least partly from a metallic material. In principle, it would also be conceivable for the shell element 30a to be made from an injection-molding.

In principle, at least a portion of the shell element 30a may at least partially form a rear visible surface 42a of the backrest 20a. In principle, the shell element 30a may however also be trimmed on its rear side 44a so that it is not visible from the outside in fully mounted state of the seat device 12a.

The backrest 20a has a covering element 46a. The covering element 46a is coupled to the base frame 24a and to the shell element 30a. The covering element 46a contacts the shell element 30a. In the present case, the covering element 46a contacts the shell element 30a on the front side 32a of the shell element 30a. The covering element 46a partly forms the backrest support surface 22a. The covering element 46a is formed at least substantially from a textile. The covering element 46a is clamped in the base frame 24a. The covering element 46a is clamped between the lateral frame elements 26a, 28a. The covering element 46a is connected at least by form fit to the lateral frame elements 26a, 28a. The covering element 46a has piping at its lateral ends. The piping is configured to be coupled to one of the piping rails of the lateral frame elements 26a, 28a. The covering element 46a extends over at least 40% of a maximal longitudinal extent of the backrest 20a. The shell element 30a and the covering element 46a together at least substantially form the backrest support surface 22a.

The covering element 46a is arranged at least substantially in a region above the shell element 30a. The covering element 46a is arranged between the shell element 30a and a crossbeam 48a of the backrest 20a. The covering element 46a, in particular at its upper end, is attached to the crossbeam 48a. The covering element 46a is connected to the crossbeam 48a by force fit and/or form fit. The crossbeam 48a is arranged in the upper region 50a of the backrest 20a. The crossbeam 48a is part of a crossbeam unit (not shown in detail) which is arranged in the upper region 50a of the backrest 20a and connects together the lateral frame elements 26a, 28a. In the present case, the upper region 50a of the backrest 20a is arranged in an upper third of the backrest 20a. The crossbeam 48a connects together the lateral frame elements 26a, 28a. In the present case, the crossbeam 48a is arranged in a shoulder region of an average passenger. The upper region 50a of the backrest 20a extends from the backrest upper edge 36a towards the mounting plane 16a. In the present case, the crossbeam 48a is spaced from the backrest upper edge 36a towards the mounting plane 16a. In principle however, it would also be conceivable that the crossbeam 48a forms the backrest upper edge 36a, apart from any covering element and/or loose cover which may be provided there. In principle, the crossbeam 48a may be part of the base frame 24a. In principle, it would also be conceivable that the lateral frame elements 26a, 28a and the crossbeam 48a are implemented as a continuous backrest yoke. The backrest yoke in this case would then form the base frame 24a.

The shell element 30a has a protrusion 54a in an upper region 52a of the shell element 30a. The protrusion 54a extends towards the crossbeam 48a of the backrest 20a. The protrusion 54a is arranged in a middle of the upper region 52a of the shell element 30a. The protrusion 54a forms a transition to the covering element 46a and overlaps with the covering element 46a.

In the present case, the shell element 30a has two attachment regions 56a, 58a. In the attachment regions 56a, 58a, the covering element 46a is attached to the shell element 30a. The covering element 46a is connected to the shell element 30a by force fit and/or form fit, in particular in the attachment regions 58a, 58a. The shell element 30a and the covering element 46a are arranged overlapping in a region above the attachment regions 56a, 58a. The covering element 46a and the shell element 30a are connected together by hook-and-loop connections 60a, 62a. Alternatively, the covering element 46a and the shell element 30a could be connected together by at least one press stud connection. In principle, other connecting means deemed suitable by the person skilled in the art, for force fit and/or form fit attachment of the covering element 46a to the shell element 30a, are conceivable. Alternatively or additionally, it would also be conceivable for the covering element 46a to be connected to the shell element 30a by substance bonding. The shell element 30a in the present case has two recesses 64a, 66a which are configured for attachment of the covering element 46a to the shell element 30a. The recesses 64a, 66a are each formed as a continuous hole through the shell element 30a. The recesses 64a, 66a are slot-like. The recesses 64a, 66a are arranged in the attachment regions 56a, 58a. The shell element 30a and the covering element 46a are arranged overlapping in a region above the recesses 64a, 66a. The covering element 46a is guided through the recesses 64a, 66a. The hook-and-loop connections 60a, 62a each extend from the front side 32a of the shell element 30a through the recesses 64a, 66a to the rear side 44a of the shell element 30a. On its underside 68a, the covering element 46a forms two connecting extensions 70a, 72a which are each guided through a respective recess 64a, 66a. The connecting extensions 70a, 72a extend from the front side 32a of the shell element 30a through the recesses 64a, 66a to the rear side 44a of the shell element 30a. In principle, it would also be conceivable that the covering element 46a merely contacts the shell element 30a, in particular the protrusion 54a, but is not directly connected to the shell element 30a.

The seat device 12a comprises two bearing units 76a, 78a. The bearing units 76a, 78a are configured for supporting the backrest 20a pivotably relative to the mounting unit 14a. The bearing units 76a, 78a are each arranged at least partly in one of the lateral frame elements 26a, 28a. The attachment of the backrest 20a, in particular the attachment of the lateral frame elements 26a, 28a, to the mounting unit 14a takes place by means of the two bearing units 76a, 78a. The backrest 20a is supported pivotably relative to the mounting unit 14a via a backrest pivot axis 80a.

In the present case, the shell element 30a has two passages 82a, 84a. The passages 82a, 84a each form a mounting region for an attachment of the backrest 20a, in particular an attachment of the lateral frame elements 26a, 28a, to the mounting unit 14a. The passages 82a, 84a are each formed as a continuous hole through the shell element 30a. The passages 82a, 84a are each designed to provide access from the backrest support surface 22a to one of the bearing units 76a, 78a. The passages 82a, 84a each form an area which amounts to maximum 15 cm². The passages 82a, 84a are arranged between the lateral frame elements 26a, 28a. The passages 82a, 84a are each arranged in a side region of the shell element 30a. The passages 82a, 84a are each intersected by the backrest pivot axis 80a. In principle, it is conceivable that the backrest pivot axis 80a intersects the backrest support surface 22a. The backrest pivot axis 80a is guided from a first bearing unit 76a of the bearing units 76a, 78a via a space behind the shell element 30a, through a first passage 82a of the passages 82a, 84a to the front side 34a of the shell element 30a. The backrest pivot axis 80a is guided from the front side 34a of the shell element 30a through a second passage 84a of the passages 82a, 84a via a space behind the shell element 30a, to a second bearing unit 78a of the bearing units 76a, 78a.

At least in a not fully mounted state of the seat device 12a, the backrest support surface 22a is interrupted at the passages 82a, 84a. In principle, it would be conceivable that the seat device 12a has at least one filling element which, in mounted state of the seat device 12a, is arranged in the passages 82a, 84a and at least substantially fills the passages 82a, 84a. Thus an advantageously constant and uninterrupted backrest support surface 22a may be provided.

The seat device 12a comprises a padding element 86a. The padding element 86a covers the shell element 30a. The padding element 86a covers the covering element 46a. The padding element 86a transmits passenger support forces to the backrest support surface 22a. The covering element 46a is realized as a rear springing for the padding element 86a. The padding element 86a is arranged between the backrest support surface 22a and the passenger. In principle, it would also be conceivable to omit the padding element 86a. The seat device 12a comprises multiple hook-and-loop connections 74a, 88a, 90a, 92a, 94a for attaching the padding element 86a to the backrest 20a. The padding element 86a contacts the covering element 46a on a front side of the covering element 46a. The padding element 86a is connected to the covering element 46a by means of the hook-and-loop connections 88a, 90a. The padding element 86a contacts the shell element 30a on the front side 32a of the shell element 30a. The padding element 86a is connected to the shell element 30a by means of the hook-and-loop connections 74a, 92a, 94a. The hook-and-loop connections 74a, 92a, 94a are arranged in depressions in the shell element 30a. The depressions have a concave form on the front side 34a of the shell element 30a. The depressions are configured to receive a volume of the hook-and-loop connections 74a, 92a, 94a via which the padding element 86a is directly attached to the shell element 30a. In the present case, the passages 82a, 84a are at least partly arranged in one of the depressions. The passages 82a, 84a are arranged at lateral ends of this depression facing away from one another. Such an arrangement of the passages 82a, 84a allows a particularly advantageous access to the bearings units 76a, 78a, wherein the area formed by the passages 82a, 84a can be kept relatively small.

The seat device 12a comprises a cover element 96a. The cover element 96a covers the padding element 86a. The cover element 96a is realized as protection for the padding element 86a, in particular with respect to wear and soiling. The cover element 96a is arranged between the backrest support surface 22a and the passenger. Alternatively, it would also be conceivable for the passenger to be direct contact with the backrest support surface 22a, wherein the shell element 30a is realized as a visible component. The padding element 86a is arranged between the shell element 30a and the cover element 96a. The padding element 86a is arranged between the covering element 46a and the cover element 96a.

In the present case, the seat device 12a comprises a headrest unit 98a which is arranged in the upper region 50a of the backrest 20a. The headrest unit 98a forms part of the backrest support surface 22a. The shell element 30a, the covering element 46a and the headrest unit 98a together form the backrest support surface 22a. In principle however, the headrest unit 98a may be omitted. It is conceivable that the covering element 46a extends at least substantially up to the backrest upper edge 36a.

The seat device 12a comprises a lining element 100a. The lining element 100a is arranged on a rear side of the backrest 20a. The lining element 100a is connected to the base frame 24a. The lining element 100a is configured for lining the backrest 20a, in particular the base frame 24a, on a side of the backrest 20a facing away from the backrest support surface 22a. The lining element 100a forms at least a majority of the rear visible surface 42a of the backrest 20a. The lining element 100a may be configured for attachment of the cover element 96a.

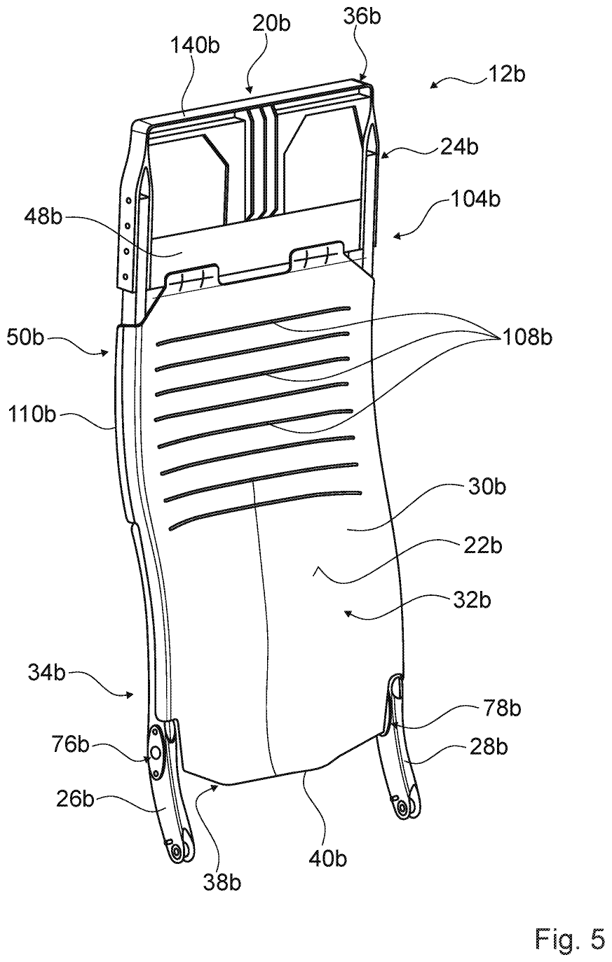

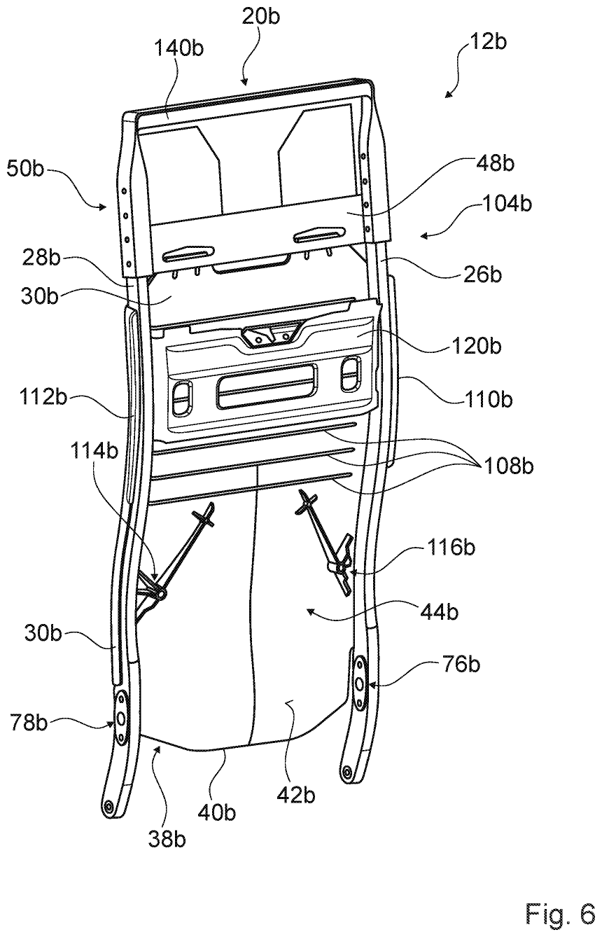

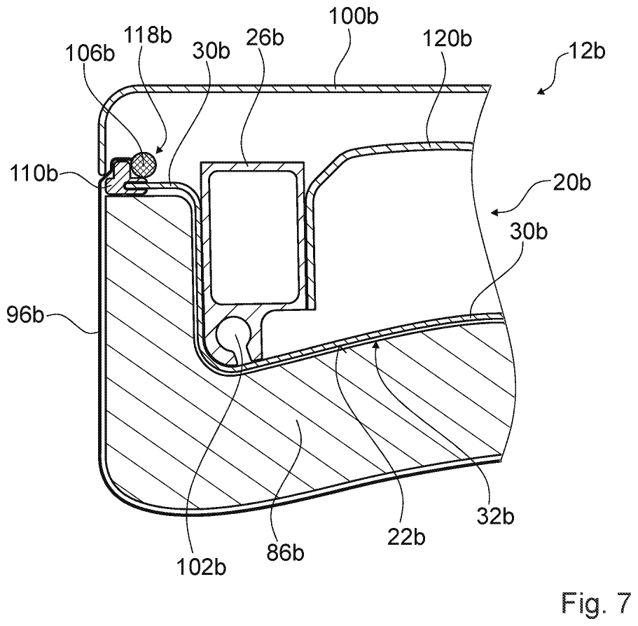

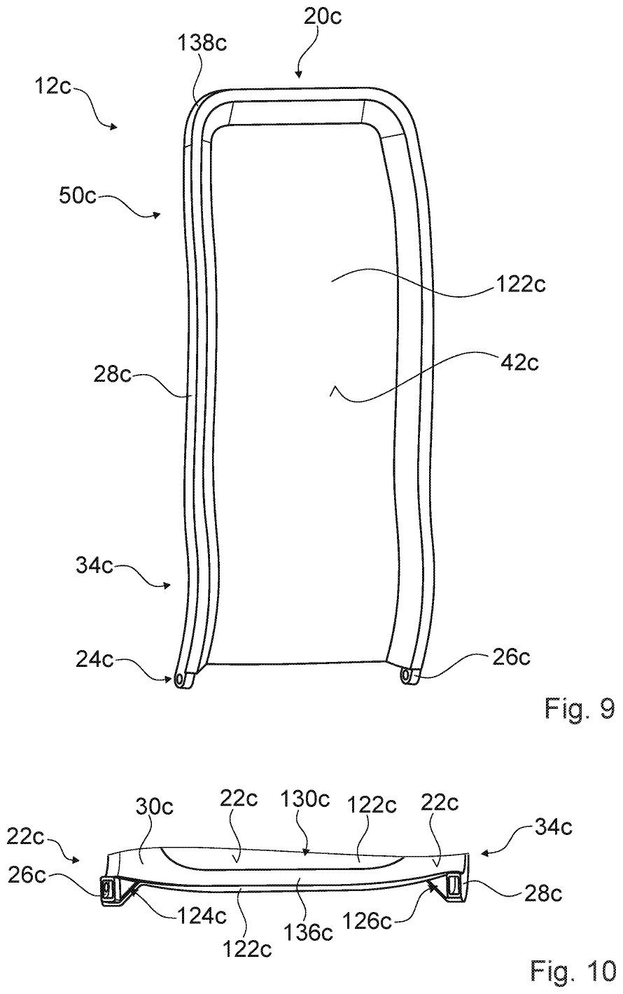

FIGS. 5 to 10 show two further exemplary embodiments of the invention. The descriptions which follow and the drawings are substantially restricted to the differences between the exemplary embodiments, wherein with respect to components with the same designation, in particular with the same reference signs, in principle reference may be made to the drawings and/or the description of the other exemplary embodiments, in particular of FIGS. 1 to 4. To distinguish the exemplary embodiments, the letter a is attached to the reference signs of the exemplary embodiment in FIGS. 1 to 4. In the exemplary embodiments of FIGS. 5 to 10, the letter a has been replaced by the letters b and c.

In FIGS. 5 to 7, a seat device 12b of a second exemplary embodiment is shown. The seat device 12b is part of an aircraft seat. The seat device 12b comprises a backrest 20b. The backrest 20b has a backrest support surface 22b. The backrest 20b has a base frame 24b. The base frame 24b comprises two lateral frame elements 26b, 28b. The lateral frame elements 26b, 28b each have a piping rail 102b. The backrest 20b has a shell element 30b. The shell element 30b at least substantially completely forms the backrest support surface 22b. The shell element 30b has a concave form on a front side 32b of the shell element 30b. In a lower region 38b of the shell element 30b, the shell element 30b has a shape convex towards a mounting plane. The shell element 30b has a lower edge 40b which has a shape convex towards the mounting plane. The backrest 20b comprises a crossbeam 48b. The crossbeam 48b is part of a crossbeam unit which connects together the lateral frame elements 26b, 28b in an upper region 50b of the backrest 20b by means of two transverse connections. The transverse connections are formed by the crossbeam 48b of the backrest 20b and a further crossbeam 140b of the backrest 20b. The further crossbeam 140b is arranged above the crossbeam 48b and spaced apart from the crossbeam 48b. The further crossbeam 140b is connected to the crossbeam 48b via the crossbeam unit. The further crossbeam 140b forms a backrest upper edge 36b of the backrest 20b. The seat device 12b comprises two bearing units 76b, 78b which are configured to support the backrest 20b pivotably relative to a mounting unit of the aircraft seat. The seat device 12b comprises a padding element 86b. The seat device 12b comprises a cover element 96b. The sealing device 12b has a cover fastening element 106b. The seat device 12b comprises a lining element 100b.

In contrast to the first exemplary embodiment, the backrest 20b has no covering element. The shell element 30b extends over at least 60% of a maximal longitudinal extent of the backrest 20b. The shell element 30b extends from a lower region 34b of the backrest 20b to the upper region 50b of the backrest 20b. The shell element 30b is attached to the crossbeam 48b of the backrest 20b at a top side 104b of the shell element 30b. The upper end of the shell element 30b is fixedly connected to the crossbeam 48b. At least a portion of the shell element 30b at least partly forms a rear visible surface 42b of the backrest 20b. The shell element 30b forms at least a lower portion of the rear visible surface 42b of the backrest 20b.

The shell element 30b has several, at least substantially horizontally running slots 108b. The shell element 30b is formed as one piece. The slots 108b are formed as cutouts from the shell element 30b. The slots 108b extend over a length of at least 50% of a maximal transverse extent of the shell element 30b. The slots 108b have a maximal height extent of 3 cm. The slots 108b are arranged in an upper region 50b, in particular in an upper half, of the shell element 30b. Because of the slots 108b, the shell element 30b may be implemented in an advantageously flexible manner, whereby an advantageously high comfort can be achieved.

The shell element 30b comprises multiple function elements 110b, 112b, 114b, 116b which are molded, in particular injection-molded, onto the shell element 30b. The shell element 30b, which is in particular embodied as an organic sheet, is in this case heated, in particular melted, and shaped into its definitive form, wherein the function elements 110b, 112b, 114b, 116b are molded onto the shell element 30b in the same production step, in particular by injection molding.

The shell element 30b comprises a first function element 110b. The first function element 110b is arranged at a lateral end of the shell element 30b. The lateral end of the shell element 30b is arranged outside the base frame 24b. The first function element 110b forms a receiving space 118b for the cover fastening element 106b. The first function element 110b in this case has a substantially T-shaped cross-section. Alternatively, the first function element 110b may have a substantially L-shaped cross-section, or another cross-section which the person skilled in the art deems suitable for clamping. The receiving space 118b is realized as an undercut, whereby the cover fastening element 106b is held in the receiving space 118b in mounted state. In principle, it is conceivable that the first function element 110b is formed from a soft plastic. The cover fastening element 106b is configured for fastening the cover element 96b to the backrest 20b. The cover fastening element 106b is coupled to the cover element 96b. In principle, the cover fastening element 106b may be fixedly connected to the cover element 96b. Alternatively, the cover fastening element 106b may be guided sliding at least in portions in a channel of the cover element 96b. In the present case, the cover fastening element 106b is formed as a cable, a cord or a strap. The cover fastening element 106b may be elastic, for example as an expanding cable.

In a fully mounted state of the seat device 12b, the cover element 96b is arranged directly between the lining element 100b and the first function element 110b. The lining element 100b and the first function element 100b form a clamping gap which is configured for fixing the cover element 96b by force fit, in particular by friction fit. The lining element 100b clamps the cover element 96b against the first function element 110b.

The shell element 30b has a second function element 112b which is arranged at a lateral end of the shell element 30b opposite the first function element 110b. The second function element 112b is realized identically to the first function element 110b but as a mirror image.

The shell element 30b has a third function element 114b and a fourth function element 116b. The third function element 114b and the fourth function element 116b are arranged on a rear side 44b of the shell element 30b and serve for attachment of a function component (not shown in detail) to the backrest 20b. The third function element 114b and the fourth function element 116b each form a fastening element, in particular a screw insert. The fastening elements, in particular the screw insert, are made of a metallic material. The fastening elements are inserted during the same production step in which the function elements 114b, 116b are molded onto the shell element 30b, and are molded onto the shell element 30b by injection molding. By means of the third function element 114b and the fourth function element 116b, for example a function component embodied as a literature pocket can be attached to the shell element 30b. The third function element 114b and the fourth function element 116b are each additionally configured for reinforcement, in particular stiffening, of the shell element 30b in the lower region 34b of the backrest 20b. The third function element 114b and the fourth function element 116b here each form at least one stiffening rib.

The seat device 12b comprises a backrest bridge 120b. The backrest bridge 120b is arranged behind the shell element 30b. The backrest bridge 120b is arranged at the height of the upper region 50b of the shell element 30b. The backrest bridge 120b connects together the lateral frame elements 26b, 28b. The backrest bridge 120b is configured to stiffen the base frame 24b. The backrest bridge 120b is designed to provide an attachment for at least one further function component. The further function component may for example be embodied as a table device and/or as a screen.

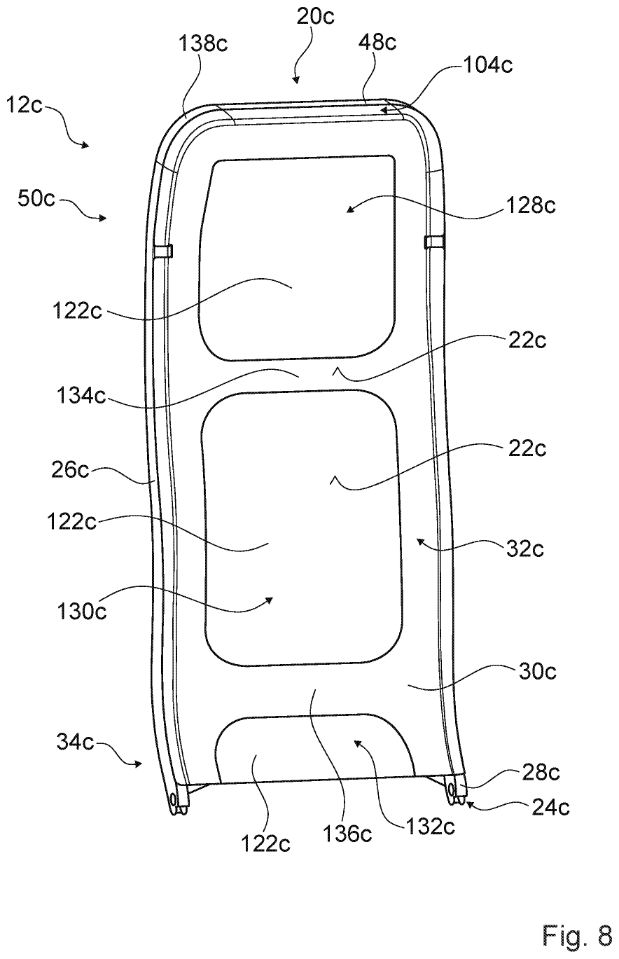

In FIGS. 8 to 10, a seat device 12c of a third exemplary embodiment is shown. The seat device 12c is part of an aircraft seat. The seat device 12c comprises a backrest 20c. The backrest 20c has a backrest support surface 22c. The backrest 20c has a base frame 24c. The base frame 24c comprises two lateral frame elements 26c, 28c. The base frame 24c has an upper frame element 138c. The upper frame element 138c is embodied as a crossbeam 48c of the backrest 20c. The lateral frame elements 26c, 28c are connected together via the upper frame element 138c. The base frame 24c is formed as one piece. The backrest 20c has a shell element 30c. The shell element 30c has a concave form on a front side 32c of the frame element 30c. The shell element 30c partly forms the backrest support surface 22c. The shell element 30c extends over at least 80% of a maximal longitudinal extent of the backrest 20c. The shell element 30c extends from a lower region 34c of the backrest 20c to an upper region 50c of the backrest 20c. The shell element 30c is connected to the crossbeam 48c at a top side 104c of the shell element 30c. The seat device 12c may comprise a padding element and/or a cover element. In the present case, the backrest 20c is rigidly mounted on a mounting unit of the aircraft seat.

In contrast to the first and second exemplary embodiments, the backrest 20c has a further shell element 122c. The further shell element 122c extends over at least 80% of a maximal longitudinal extent of the backrest 20c. The further shell element 30c extends from a lower region 34c of the backrest 20c to the upper region 50c of the backrest 20c. The further shell element 122c at least substantially terminates the backrest 20c towards the rear. The further shell element 122c forms a rear visible surface 42c of the backrest 20c. The further shell element 122c has a concave form on a side facing away from the rear side of the shell element 30c and forming the rear visible surface 42c of the backrest 20c. The further shell element 122c is embodied as a lining element which at least substantially completely covers a rear side of the backrest 20c. In the present case, the further shell element 122c is free from function components which could be mounted on the rear side of the backrest 20c. In principle however, it is also conceivable that the further shell element 122c is configured for integration of at least one function component on the rear side of the backrest 20c.

The shell element 30c and the further shell element 122c are directly connected together. The shell element 30c and the further shell element 122c are connected together in the region between the two lateral frame elements 26c, 28c. The shell element 30c lies on the base frame 24c on a front side of the base frame 24c. The further shell element 122c lies on the base frame 24c on a rear side of the base frame 24c. The seat device 12c forms an interstice 124c with an at least substantially triangular cross-section (see FIG. 10) between the shell element 30c, the lateral frame element 26c and the further shell element 122c. The seat device 12c forms a further interstice 126c with an at least substantially triangular cross-section between the shell element 30c, the lateral frame element 28c and the further shell element 122c.

The further shell element 122c is realized as a hot-shaped panel, in particular an aluminum sheet. Alternatively, the further shell element 122c may be formed from a plastic, in particular a fiber-reinforced plastic, or from another material deemed suitable by the person skilled in the art.

The shell element 30c has multiple cutouts 128c, 130c, 132c. The further shell element 122c is arranged directly behind the cutouts 128c, 130c, 132c. The further shell element 122c partly forms the backrest support surface 22c. The cutouts 128c, 130c, 132c are arranged in a middle region inside the base frame 24c, in which the shell element 30c and the further shell element 122c are directly connected together. The cutouts 128c, 130c, 132c extend over a width of maximum 75% of a maximal transverse extent of the shell element 30c. The cutouts 128c, 130c, 132c are separated from one another by at least two webs 134c, 136c of the shell element 30c running continuously in a transverse direction.

1. A seat device, in particular an aircraft seat device, with a backrest having a base frame which comprises two lateral frame elements, and having a shell element which is connected to the lateral frame elements and at least partly forms a backrest support surface.

2. The seat device as claimed in claim 1, wherein the shell element is arranged exclusively in a lower region of the backrest.

3. The seat device as claimed in claim 1, wherein the backrest has at least one covering element, which is coupled to the base frame and to the shell element and partly forms the backrest support surface-.

4. The seat device as claimed in claim 3, wherein the covering element is arranged between the shell element and a crossbeam of the backrest, wherein the crossbeam is arranged in an upper region of the backrest.

5. The seat device as claimed in claim 3, wherein the shell element has at least one attachment region in which the covering element is attached to the shell element.

6. The seat device as claimed in claim 1, wherein the shell element comprises at least one passage which forms a mounting region for a connection of the backrest, in particular a connection of the lateral frame elements, to a mounting unit.

7. The seat device as claimed in claim 4, wherein the shell element, in an upper region of the shell element, has a protrusion extending towards the crossbeam.

8. The seat device as claimed in claim 1, wherein the shell element, in a lower region of the shell element, has a shape that is convex towards a mounting plane.

9. The seat device as claimed in claim 1, wherein the shell element, on a top side of the shell element, is connected to a crossbeam of the backrest.

10. The seat device as claimed in claim 1, wherein the shell element extends over at least 60% of a maximal longitudinal extent of the backrest.

11. The seat device as claimed in claim 1, wherein the shell element comprises at least one function element which is molded, in particular injection-molded, onto the shell element.

12. The seat device as claimed in claim 11, wherein the at least one function element is arranged on at least one lateral end of the shell element and forms a receiving space for a cover fastening element.

13. The seat device as claimed in claim 11, wherein the at least one function element is arranged on a rear side of the shell element and is configured for attachment of at least one functional component to the backrest.

14. The seat device as claimed in claim 1, wherein at least a portion of the shell element at least partly forms a rear visible surface of the backrest.

15. The seat device as claimed in claim 1, wherein the backrest has a further shell element, which at least substantially terminates the backrest rearwards and forms a rear visible surface of the backrest, wherein the shell element and the further shell element are directly connected together.

16. An aircraft seat with a seat device as claimed in claim 1.
